(19) United States
(12) Patent Application Publication
(10) Pub. No.: US 2015/0030274 A1
(43) Pub. Date: Jan. 29, 2015

(54) ROLLER BEARING HAVING INTERNAL LUBRICATION

(71) Applicants: Thierry Adane, Tours (FR); Stephane Cordier, Tours (FR); Jean-Luc Gardelle, Flowery Branch, GA (US)

(72) Inventors: Thierry Adane, Tours (FR); Stephane Cordier, Tours (FR); Jean-Luc Gardelle, Flowery Branch, GA (US)

(21) Appl. No.: 14/002,891

(22) PCT Filed: Mar. 1, 2011
(86) PCT No.: PCT/EP2011/053029

§ 371 Date: Sep. 3, 2013

(51) Int. Cl. F16C 33/66; F16C 19/04

(52) U.S. Cl. CPC F16C 33/6611; F16C 19/04; F16C 33/6648
USPC 384/469; 384/462

(57) ABSTRACT

The rolling bearing comprises an inner ring, an outer ring, at least one row of rolling elements disposed between raceways provided on the rings, and an annular housing inside which at least one of the rings is arranged. The ring provides two parts and each of the two parts delimits with the housing a closed space inside which a lubricant is located. The rolling bearing further comprises passage means for the lubricant to pass from the closed spaces to the raceways.

The ratio between the thickness of a guiding portion of each of the two parts delimiting the raceway and the outer diameter of the bearing is from 0.7% to 3%.

In a second embodiment, the ratio between the thickness of the guiding portion and the outer diameter is and preferably from 1.1% to 1.9%.

The present invention relates to rolling bearings, in particular rolling bearings having an inner ring and an outer ring with one or more rows of rolling elements, for example balls. The rolling bearings may be, for example, those used in industrial electric motors or in motor vehicle gearboxes.

In such applications, the bearings are mainly loaded radially. The service life of the rolling bearing is essentially related to the lubrication of the bearing. Any defect in lubricating generally leads to rapid degradation and to failure of the rolling bearing.

For instance, a known deep groove ball bearing has two seals delimiting with the inner and outer rings a chamber inside which a lubricant such as grease has been introduced during the assembly of the bearing. Such a bearing is called lubricated “for life”. However, in the long term, the mixing of the grease, combined with its ageing and with the heating cycles that the bearing undergoes, cause the grease to degrade. It is possible to envisage periodic regreasing operations for this type of rolling bearings. However, these operations are expensive.

In order to avoid such periodic regreasing operations, FR-A1-2 923 277 discloses a rolling bearing comprising an inner ring and an outer ring with at least one row of rolling elements, and an annular housing surrounding the outer ring. Said outer ring is in two parts and each part forms with the housing a closed space, inside which grease or oil is located. The closed spaces function as a grease or oil reservoirs. Passage means for the lubricant are provided on the two parts of the outer ring for the lubricant to pass from the closed spaces towards the rolling elements. Such a rolling bearing is able to operate for a long time by virtue of internal lubrification.

It is a particular object of the present invention to provide a rolling bearing having internal lubrification in which the lubricant flow directed towards the rolling elements is improved during use and which is simple to manufacture and economic.

In one embodiment, the rolling bearing comprises an inner ring, an outer ring, at least one row of rolling elements disposed between raceways provided on the rings, and an annular housing inside which at least one of said rings is arranged, said ring being in two parts and each of the two parts delimiting with the housing a closed space inside which a lubricant is located. The rolling bearing further comprises passage means for the lubricant to pass from the closed spaces to the raceways. The ratio between the thickness of a guiding portion of each of the two parts of said ring delimiting the raceway and between the outer diameter of the bearing is from 0.7% to 3%, and preferably from 1.1% to 1.9%.

In one embodiment, wherein the ratio between the thickness of each of the guiding portions and the diameter of the rolling elements is from 5.5% to 22%, and preferably from 8.5% to 15%.

Advantageously, radial portions of the two parts of said ring are in axial contact with one another in a free state of the bearing, and the flexibility of at least one of said two parts is adapted to enable, under a predetermined rolling elements pass frequency, an axial displacement of the corresponding radial portion towards the outside to leave an axial clearance between the radial portions. The predetermined rolling elements pass frequency may be from: (0.35×nIR/60)×Z and (0.45×nIR/60)×Z, with nIR corresponding to the rotational speed of inner ring in revolutions per minute (rpm) and Z corresponding to the number or rolling elements.

In one embodiment, the passage means for the lubricant comprising through-holes provided on the radial portion of each of the two parts of said ring. Advantageously, the through-holes at least partly face one another to put the two closed spaces into communication.

The guiding portion of each of the two parts of said ring may be connected to the radial portion.

In a preferred embodiment, each of the two parts of said ring has a constant thickness.

In one embodiment, the bending strength of each of the two parts of said ring is up to 250 MPa.

The lubricant may be grease based on oil(s). Alternatively, the lubricant may be oil contained in porous elements fitted inside the closed spaces.

In one embodiment, each of the two parts of said ring comprises an axial portion connected to the guiding portion and having radial face spaced apart from a radial flange of the housing so as to leave an axial clearance forming the passage means for the lubricant. The passage means may also comprise radial holes provided on the axial portion of each of the two parts of said ring.

In one embodiment, each of the two parts of said ring comprises an outer axial portion in radial contact with an axial portion of the housing, a radial portion, the guiding portion and an inner axial portion, the closed space being delimited by said portions of the ring and a radial flange of the housing.

In a preferred embodiment, each of the two parts of said ring is made of stamped metal sheet.

According to another aspect, it is proposed an electric motor or generator comprising at least one rolling bearing as previously defined.

The present invention and its advantages will be better understood by studying the detailed description of a specific embodiment given by way of non-limiting example and illustrated by the appended drawings on which:

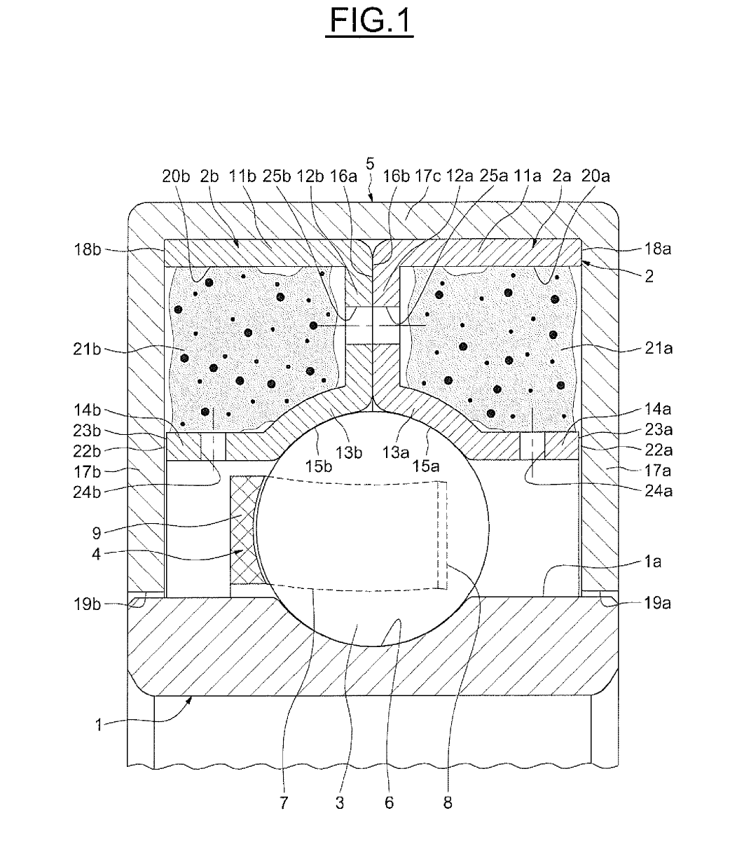

FIG. 1 is an axial half-section of a rolling bearing according to an example of the invention, and

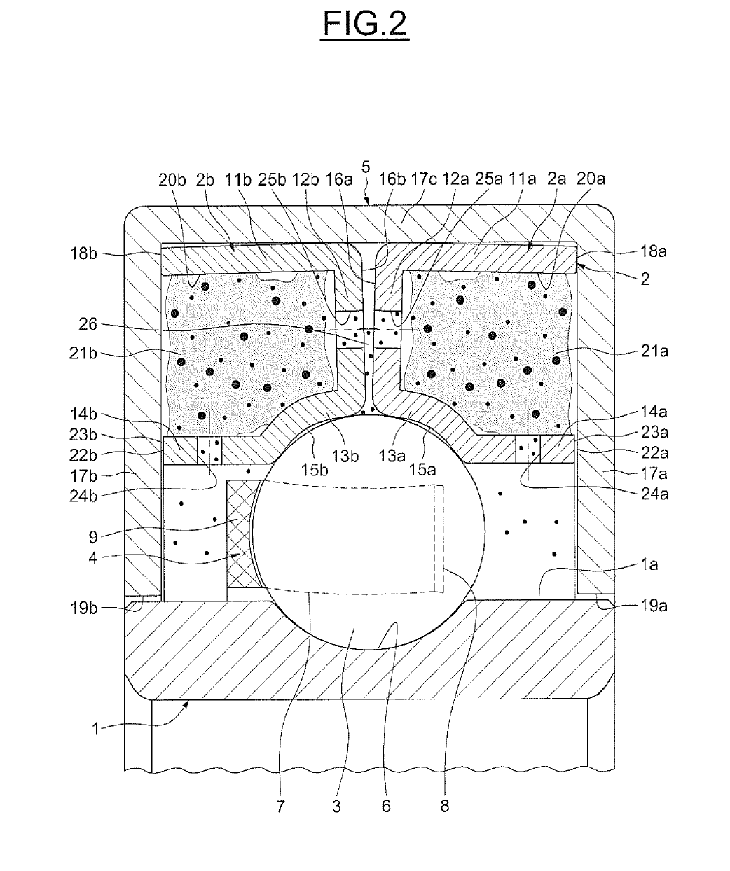

FIG. 2 is an axial half-section of the rolling bearing of FIG. 1 in a deformed state due to radial loads applied and rolling elements pass frequency.

As illustrated on FIG. 1, which illustrate an embodiment of a rolling bearing according to the invention, said bearing comprising an inner ring 1 and an outer ring 2 consisting of two outer parts or half-rings 2a, 2b, a row of rolling elements 3 that consist in the example illustrated of balls, and a cage 4 to hold said rolling elements and disposed between the inner ring 1 and the outer ring 2. The rolling bearing also comprises an annular enclosing ring or housing 5 surrounding the two outer half-rings 2a, 2b.

In this example, the inner ring 1 is designed to be mounted on a rotary member. It thus constitutes the rotating ring of the bearing while the outer ring 2 constitutes the non-rotating ring. The inner ring 1 is solid and has a toroidal groove 6 provided on its exterior cylindrical surface 1 a and forming a raceway for the rolling elements 3. The radius of curvature of the groove 6 is slightly greater than the radius of the rolling elements. The inner ring 1 may be manufactured by machining or by pressing a steel blank which is then ground and optionally lapped at the raceway in order to give the ring 1 its geometric characteristics and its final surface finish.

The cage 4 comprises a plurality of open cavities 7 bounded by external retaining claws 8. The cavities 7 are advantageously spherical with a diameter slightly greater than that of the rolling elements 3 so as to receive and hold the latter. The cavities 7 are made around the periphery of an annular body of the cage 4, leaving a heel 9 opposite the openings of the cavities 7. These openings bounded in each case by two opposing claws 8 have a width slightly smaller than the diameter of the rolling elements 3. The rolling elements 3 are snap-fitted by moving the claws 8 apart elastically. Alternatively, the cage may have other means than cavities 7 and claws 8 for retaining the rolling elements. The cage 4 can be made of moulded plastic or of metal.

In this embodiment, the two parts 2a and 2b of the outer ring 2 are identical and symmetrical with respect to the radial plane of symmetry of the bearing in order to reduce the manufacturing costs. As an alternative, it is also possible to foresee parts 2a, 2b non-symmetric. These two outer half-rings 2a, 2b may advantageously be manufactured by cutting and stamping a metal sheet, the pieces obtained then being hardened by heat treatment. Each of the two half-rings 2a, 2b has a constant thickness. The raceways may then be ground and/or lapped in order to give them their geometric characteristics and their definitive surface finish. Since the two half-rings 2a, 2b are identical in this example, only one of them, having the reference “a”, will be described here, it being understood that the identical elements of the other half-ring 2b have the reference “b”.

The half-ring 2a of the outer ring 2 comprises an outer cylindrical axial portion 11a, an annular radial portion 12a, a toroidal portion 13a and an inner cylindrical axial portion 14a. The radial portion 12a is connected to the outer axial portion 11a and to the toroidal portion 13a. The toroidal portion 13a delimits a toroidal raceway 15a for the rolling elements 3. The toroidal portion 13a forms a guiding portion for the rolling elements 3. The radius of curvature of the raceway 15a is slightly greater than the radius of the rolling elements 3. The toroidal portion 13a is also connected to the inner axial portion 14a. The toroidal portion 13a extends axially towards the outside of the rolling bearing with the inner axial portion 14a. The two outer half-rings 2a, 2b are positioned with the radial faces 16a, 16b of the radial portions 12a, 12b in axial contact with one another, approximately in the radial plane of symmetry of the rolling bearing and the rolling elements 3.

The housing 5, which is advantageously made of stamped metal sheet, comprises two radial flanges 17a, 17b and an outer axial portion 17c connected to the two radial flanges 17a, 17b so as to surround the two half-rings 2a, 2b and to hold them against one another in the axial direction. The half-rings 2a, 2b are centred in the axial portion 17 of the housing 5 by radial contact between the two axial portions 11a, 11b and the bore of the axial portion 17c. The outer radial faces 18a, 18b which form the annular edges of the two outer axial portions 11a, 11b are respectively in contact with the radial flanges 17a, 17b of the housing 5. The two radial flanges 17a, 17b extend radially inwards towards the outer cylindrical surface 1a of the inner ring 1. The inner edges 19a, 19b leave a radial clearance with respect to said cylindrical surface 1a. The outer radial face of each flange 17a, 17b lies in a radial plane containing a radial face of the inner ring 1.

Each of the outer half-rings 2a, 2b delimits, with the housing 5, an annular closed space 20a, 20b acting as lubricant reservoir, the lubricant 21a, 21b contained in these spaces 20a, 20b being shown schematically. More specifically, the closed space 20a is delimited by the outer axial portion 11a, the radial portion 12a, the toroidal portion 13a and the inner axial portion 14a, and facing these portions, a part of the radial flange 17a of the housing 5.

Passage means may be provided to allow the lubricant 21a, 21b to pass from the closed spaces 20a, 20b to the raceways 6 and 15a, 15b. These passage means are of several types. There is an axial clearance 22a, respectively 22b, between the inner face of the radial flange 17a, respectively 17b, and the outer radial face 23a, respectively 23b, that forms an annular edge of the inner axial portion 14a, respectively 14b. These clearances 22a, 22b allow the lubricant contained in the annular reservoir 20a, 20b to escape or to emerge towards the rolling elements 3. It would be conceivable for the clearance 22a, 22b to be replaced by a plurality of radial grooves or notches defined between ribs provided on the faces 23a, 23b.

Other passage means for the delivery of the lubricant 21a, 21b consist, in the embodiment illustrated, of a plurality of radial communication through-holes 24a, 24b made in the thickness of the inner axial portion 14a, 14b which allow the lubricant 21a, 21b to be dispersed in the radial space defined between the inner ring 1 and the outer ring 2 where are housed the rolling elements 3. The lubricant 21a, 21b contained in the closed spaces 20a, 20b can flow towards the rolling elements 3 through the axial clearance 22a, 22b and the through-holes 24a, 24b. Alternatively or in combination, a plurality of communication through-holes may be provided in the thickness of toroidal portion 13a, 13b or at the region where the inner axial portion 14a, 14b and the toroidal portion 13a, 13b meet. Such an arrangement allows the lubricant 21a, 21b to be dispersed directly onto the rolling element 3 at the raceways 15, 15b.

As will be described in greater detail later, the passage means for the lubricant 21a, 21b to pass from the closed spaces 20a, 20b to the raceways 6, and 15a, 15b also comprises a plurality of axial through-holes 25a, 25b made in the thickness of the radial portion 12, 12b of the two half-rings 2a, 2b and at least partly face one another. This arrangement also allows the two closed spaces 20a, 20b to communicate each other. In the illustrated embodiment, the through-holes 25a, 25b face one another.

The various elements of the rolling bearing are assembled as follows. Once the rolling elements 3 have been inserted in the cavities 7 of the cage 4 and the whole has been fitted on the inner ring 1, the two half-rings 2a, 2b are positioned around the row of rolling elements 3. Lubricant 21a is provided into the space 20a which constitutes a first lubricant reservoir between the half-ring 2b and the housing 5. Lubricant 21b is also provided into the space 20b which constitutes a second lubricant reservoir and into the volume remaining between the inner ring 1 and the outer ring 2. It should be noted that the lubricant used to fill the spaces 20a and 20b may be different from that which is placed between the inner ring 1 and the outer ring 2 in contact with the rolling elements 3.

The housing 5 has, at this stage of the assembly process, an L-shaped structure with an outer cylindrical portion forming the axial portion 17c being connected to a radial portion forming one of the radial flanges, for example the flange 17b. The housing thus created is then fitted over the two half-rings 2a, 2b. Once the two outer half-rings 2a, 2b have been put in place in the L-shaped structure of the housing 5, the outer cylindrical portion of the housing 5 is folded over on the side opposite the radial flange 17b to form the second radial flange 17a opposite the first and to hold the two half-rings 2a, 2b against one another by way of their respective outer axial portions 11a and 11b. Once the assembly process is complete, the housing 5 and the two outer half-rings 2a, 2b delimit annular closed volumes or spaces 20a, 20b forming lubricant reservoirs.

In the described embodiment, the lubricant 21a, 21b may advantageously be grease based on oil(s) compatible with the lubricant originally placed between the inner ring 1 and the outer ring 2. The lubricant 21a, 21b can pass through the various passage means towards the inner part of the rolling bearing and the rolling elements 3. This passage occurs through the axial clearances 22a, 22b and through the through-holes 24a, 24b. The viscosity of the lubricant 21a, 21b used could easily be adjusted depending on requirements such that at the normal operating temperature the lubricant is able to pass through the abovementioned passages. Preferably, the internal surfaces of the spaces 20a, 20b have an oleophobic coating which prevents the lubricant adhering to the inner walls and thus promotes it to be transferred.

According to an analysis made by the applicant, it was found that a good lubrication of the rolling elements 3 is obtained with a ratio between the thickness of each of the toroidal portions 13a, 13b of the two outer half-rings 2a, 2b and the outer diameter of the housing 5 from 0.7% to 3%, and preferably from 1.1% to 1.9%.

The applicant has determined that, with such a range, the circulation of rolling elements 3 on the raceways 15a, 15b of the toroidal portions 13a, 13b leads to vibrations of said portions which are adapted to increase the oil bleeding phenomenon from grease contained into the closed spaces 20a, 20b. The flow of oil passing through the axial clearances 22a, 22b and the through-holes 24a, 24b increases thus allowing satisfactory lubrication of the rolling elements 3. The rotational speed considered for this oil bleeding phenomenon is up to 650000 n×dm, with n corresponding to the rotational speed in revolution per minutes (rpm) and dm=0.5 (d+D) with d corresponding to the diameter of the bore of the inner ring in mm and D corresponding to the diameter of the outer surface of the outer ring in mm. As previously mentioned, the two half-rings 2a, 2b have a constant thickness. The ratio between the thickness of the half-rings 2a, 2b and the outer diameter of the rolling bearing is from 0.7% to 3%, and preferably from 1.1% to 1.9%. The ratio between the thickness of each of the guiding portions 13a, 13b and the diameter of the rolling elements 3 is from 5.5% to 22%, and preferably from 8.5% to 15%. For instance, for a rolling bearing with a housing having an outer diameter equal to 130 mm and rolling elements 3 having a diameter equal to 17,462 mm, the thickness of the half-rings 2a, 2b may be comprised between 1.48 mm and 2.6 mm, and preferably equal to 2 mm. When the rolling elements pass frequency is from (0.35×nIR/60)×Z and (0.45×nIR/60)×Z, with nIR corresponding to the rotational speed of inner ring in revolutions per minute (rpm) and Z corresponding to the number or rolling elements, leading to vibrations of the outer half-rings 2a and 2b, with the design of said half-rings and the above-mentioned ratio between the thickness of the rings and the outer diameter of the bearing, the flexibility of each of the half-rings 2a, 2b enables slight radial displacements of each of the toroidal portions 13a, 13b towards the axial portions 11a, 11b, i.e. towards the outside. With such deformations of the outer half-rings 2a and 2b, slight axial displacements of the radial portions 12a, 12b towards the outside also occur and leave an axial clearance 26 between the radial faces 16a, 16b of said radial portions as shown on FIG. 2. The axial portions 11a, 11b are also slightly deformed radially inwards. On FIG. 2, the deformations of the outer half-rings 2a and 2b have been increased for the drawing.

The volume of each of the closed spaces 20a, 20b is reduced, which increases the flow of lubricant 21a, 21b passing through the axial clearances 22a, 22b and the through-holes 24a, 24b. Besides, in such a deformed state of the outer half-rings 2a and 2b, the through-holes 25a, 25b allow the lubricant 21a, 21b to pass from the closed spaces 20a, 20b to the axial clearance 26 between the radial portions 12a, 12b to guide the lubricant directly on to the rolling elements 3 at the raceways 15a, 15b. Thus, in the deformed state of the outer half-rings, the through-holes 25a, 25b and the axial clearance 26 form passage means for the lubricant to pass from the closed space 20a, 20b towards the raceways 15a, 15b. If the radial loads applied on the rolling bearing increase, the flexibility of each of the half-rings 2a, 2b allows more flow of lubricant passing through the axial clearances 22, 22b, the through-holes 24a, 24b, 25a, 25b and the axial clearance 26, which reduce the temperature of the rolling bearing and contribute to longer service life. The bending strength of each of the two half-rings 2a, 2b may up to 250 MPa. The strain strength of each of said two half-rings 2a, 2b is 0.01% of the deformation before plastic deformation.

In the disclosed embodiment, the closed spaces 20a, 20b are filled with grease and/or oil as previously described. Alternatively, it could be possible to foresee in the two closed spaces a cellular or porous annular element saturated with oil. The cellular or porous annular elements act as sponges and under the effect of vibrations are able to release the lubricant oil which then passes as before through the passage means described hereinabove. The cellular or porous annular elements can take up the whole of the closed spaces 21a, 21b or only part thereof.

In the disclosed embodiment, the outer ring 2 comprises two half-rings 2a, 2b and the inner ring 1 is of the solid type. Alternatively, it might be possible to have the outer ring solid while the inner ring would consist of two half-rings produced in a similar way to the half-rings 2a, 2b of the disclosed embodiments. The two half-rings of the inner ring would be mounted inside a housing. The arrangement is identical to that of the embodiment illustrated, but with the elements inverted.

In such a case, it is advantageous for the inner ring formed by the two half-rings to be the rotating ring of the rolling bearing in operation. This is because, in this case, when the rolling bearing rotates, the lubricant contained in the two spaces of the half-ring is subjected to centrifugal force and tends to diffuse through the passages means towards the raceways of the rolling bearing.

In another embodiment, it could also be possible to have a rolling bearing in which the inner ring and the outer ring each comprise two half-rings enclosed in a housing as previously described. In such an embodiment, the rolling bearing has four closed spaces acting as lubricant reservoirs.

Although the present invention has been illustrated on the basis of a rolling bearing having a single row of balls, it should be understood that the invention can be applied to bearings using several rows of rolling elements, without major modifications. The invention can also be applied to different types of ball bearings, such as angular contact bearings, or else to self-aligning bearings.

1. A rolling bearing comprising:
an inner ring (1),
an outer ring (2),
at least one row of rolling elements (3) disposed between raceways (6, 15a, 15b) provided on the rings, and
an annular housing (5) inside which at least one of the rings is arranged, the ring being in two parts (2a, 2b) and each of the two parts delimiting with the housing a closed space (20a, 20b) inside which a lubricant (21a, 21b) is located,
the rolling bearing further comprising passage means for the lubricant to pass from the closed spaces to the raceways, wherein
the ratio between the thickness of a guiding portion (13a, 13b) of each of the two parts (2a, 2b) of the ring delimiting the raceway (15a, 15b) and between the outer diameter of the bearing is from 0.7% to 3%, and preferably from 1.1% to 1.9%.

2. The rolling bearing according to claim 1, wherein the ratio between the thickness of each of the guiding portions (13a, 13b) and the diameter of the rolling elements (3) is from 5.5% to 22%.

3. The rolling bearing according to claim 1, wherein radial portions (12a, 12b) of the two parts (2a, 2b) of the ring are in axial contact with one another in a free state of the bearing, the flexibility of at least one of the two parts being adapted to enable, under a predetermined rolling elements pass frequency, an axial displacement of the corresponding radial portion towards the outside to leave an axial clearance between the radial portions (12a, 12b).

4. The rolling bearing according to claim 3, wherein the predetermined rolling elements pass frequency is from:
(0.35×nIR/60)×Z and (0.45×nIR/60)×Z,
with nIR corresponding to the rotational speed of inner ring in revolutions per minute and Z corresponding to the number or rolling elements.

5. The rolling bearing according to claim 3, wherein the passage means for the lubricant comprising through-holes (25a, 25b) is provided on the radial portion (12a, 12b) of each of the two parts (2a, 2b) of the ring.

6. The rolling bearing according to claim 5, wherein the through-holes (25a, 25b) at least partly face one another to put the two closed spaces (20a, 20b) into communication,

7. The rolling bearing according to claim 3, wherein the guiding portion (13a, 13b) of each of the two parts (2a, 2b) of the ring is connected to the radial portion (12a, 12b).

8. The rolling bearing according to claim 1, wherein each of the two parts (2a, 2b) of the ring has a constant thickness.

9. The rolling bearing according to claim 1, wherein the bending strength of each of the two parts (2a, 2b) of the ring is less than or equal to 250 MPa.

10. The rolling bearing according to claim 1, wherein the lubricant (21a, 21b) is grease based on oil(s).

11. The rolling bearing according to claim 1, wherein the lubricant (21a, 21b) is oil contained in porous elements fitted inside the closed spaces (20a, 20b).

12. The rolling bearing according to claim 1, wherein each of the two parts (2a, 2b) of the ring comprises an axial portion (14a, 14b) connected to the guiding portion (13a, 13b) and having radial face (23a, 23b) spaced apart from a radial flange (17a, 17b) of the housing so as to leave an axial clearance (22a, 22b) forming the passage means for the lubricant.

13. The rolling bearing according to claim 12, wherein the passage means also comprise radial holes (24a, 24b) provided on the axial portion (14, 14b) of each of the two parts (2a, 2b) of the ring.

14. The rolling bearing according to claim 1, wherein each of the two parts of the ring comprises an outer axial portion (11a, 11b) in radial contact with an axial portion (17c) of the housing, a radial portion (12a, 12b), the guiding portion (13a, 13b) and an inner axial portion (14a, 14b), the closed space (20a, 20b) being delimited by the portions of the ring and a radial flange (17a, 17b) of the housing.

15. An electric motor or generator comprising:
at least one rolling bearing providing
an inner ring (1),
an outer ring (2),
at least one row of rolling elements (3) disposed between raceways (6, 15a, 15b) provided on the rings, and
an annular housing (5) inside which at least one of the rings is arranged, the ring being in two parts (2a, 2b) and each of the two parts delimiting with the housing a closed space (20a, 20b) inside which a lubricant (21a, 21b) is located,
the rolling bearing further comprising passage means for the lubricant to pass from the closed spaces to the raceways, wherein
the ratio between the thickness of a guiding portion (13a, 13b) of each of the two parts (2a, 2b) of the ring delimiting the raceway (15a, 15b) and between the outer diameter of the bearing is from 0.7% to 3%.

16. The rolling bearing according to claim 1, wherein the ratio between the thickness of a guiding portion (13a, 13b) of each of the two parts (2a, 2b) of the ring delimiting the raceway (15a, 15b) and between the outer diameter of the bearing is preferably from 1.1% to 1.9%.

17. The rolling bearing according to claim 1, wherein the ratio between the thickness of each of the guiding portions (13a, 13b) and the diameter of the rolling elements (3) is preferably from 8.5% to 15%.
